(19) United States
(12) Patent Application Publication
(10) Pub. No.: US 2004/0126512 A1
(43) Pub. Date: Jul. 1, 2004

(54) Structural improvement for sound case

(75) Inventor: Yueh-Hua Hsu Huang, Chung-Ho City (TW)

Correspondence Address: BACON & THOMAS, PLLC, 625 SLATERS LANE, FOURTH FLOOR, ALEXANDRIA, VA, 22314

(73) Assignee: JAZZ HIPSTER CORPORATION, Chung-Ho City (TW)

(21) Appl. No.: 10/331,483

(22) Filed: Dec. 31, 2002

(51) Int. Cl. E06B 3/24

(52) U.S. Cl. 428/34; 428/137

(57) ABSTRACT

The present invention relates to structural improvement for glass sound cases, especially those with variable formation, beautifying effects and visual variation, wherein the materials of traditional sound cases with unchangeable formation are replaced with variable aluminum or glass and a glass of variable shape being covered on either side of the one-piece hollow frame. Inside the frame installs several speakers and relative components. Also, several LED or luminous components are placed around the speakers to highlight the inner structure of the frame and the entire modeling through the transparent glass cover. With such a design wherein the frame body and the transparent glass cover can be randomly assembled, the sound case is full of variation and beautifying effects. The transparent glass covers spotlights the fast, slow, big and small vibration of the speakers inside the frame and the LEDs or luminous components add more visual variation to the sound case.

### FIELD OF THE INVENTION

The present invention relates to a structural improvement for sound cases, especially the glass sound cases with variable formation, beautifying effects and visual variation.

### BACKGROUND OF THE INVENTION

Traditional sound cases are made of opaque materials such as plank aluminum and plastic steel and formed into a closed box of unchangeable formation. Inside the case there are several speakers able to produce resonance and amply the sound.

Though the opaque structure of sound cases might provide basic sound amplification function that meets the user's requirement for perfect sound, such sound case structure still have some defects in designing, such as unchangeable formation, drabness and lack of beautifying effects. Typical sound cases are simply a cubical case, which is drab and dull. Such a design not only has little added value to consumers chasing after fashion but also fails to address modern people's need for novelty and variation. Recently, some suppliers started to make some changes to the formation of sound cases to steer people's eyeball and enhance their status in the market; yet this attempt still fails to provide a sound case that can be randomly assembled and that provides visual variation. Therefore, traditional sound cases are always limited to the characteristics as drabness, dullness and lack of variation.

To promote a product means to develop a high-practicability and high-value product. As a result, the objective for the present invention is to attract consumers' attention with a product providing outstanding beautifying effects.

In view of such defects as drabness, dullness and lack of variation and beautifying effects found in traditional sound cases, the inventor of the present invention was devoted to finding a solution and accomplished structural improvement for power cord.

### SUMMARY OF THE INVENTION

The main objective for the present invention is to provide a glass sound case with variable formation and full of visual variation and beautifying effects.

In the present invention, the materials of traditional sound cases with unchangeable formation are replaced with aluminum or glass, allowing the user to change the formation. Meanwhile, on either side of the one-piece hollow frame covers a transparent and various shapes of glass cover. Inside the frame installs several speakers and relative components. Also, several LEDs or luminous components are placed around the speakers so as to highlight the mer structure of the frame and the entire modeling through the transparent glass cover. With such a design wherein the frame body and the transparent glass covers can be randomly assembled, the sound case is full of variation and beautifying effects. The transparent glass covers spotlights the fast, slow, big and small vibration of the speakers inside the frame and the LEDs or luminous components add more visual variation to the sound case.

In the following, the embodiment illustrated is used to describe the detailed structural characteristics and operation action for the present invention.

### BRIEF DESCRIPTION OF THE DRAWINGS

FIG. 1 is a three-dimensional illustration for deformation in the present invention.

FIG. 2 is a three-dimensional illustration for formation in the present invention.

FIG. 3 is a plane illustration for application of the present invention.

FIG. 4A is a plane illustration for better application of the present invention.

FIG. 4B is a plane illustration for better application of the present invention.

FIG. 4C is a plane illustration for better application of the present invention.

FIG. 4D is a plane illustration for better application of the present invention.

FIG. 4E is a plane illustration for better application of the present invention.

FIG. 4F is a plane illustration for better application of the present invention.

FIG. 4G is a plane illustration for better application of the present invention.

FIG. 4H is a plane illustration for better application of the present invention.

### DETAILED DESCRIPTION OF THE INVENTION

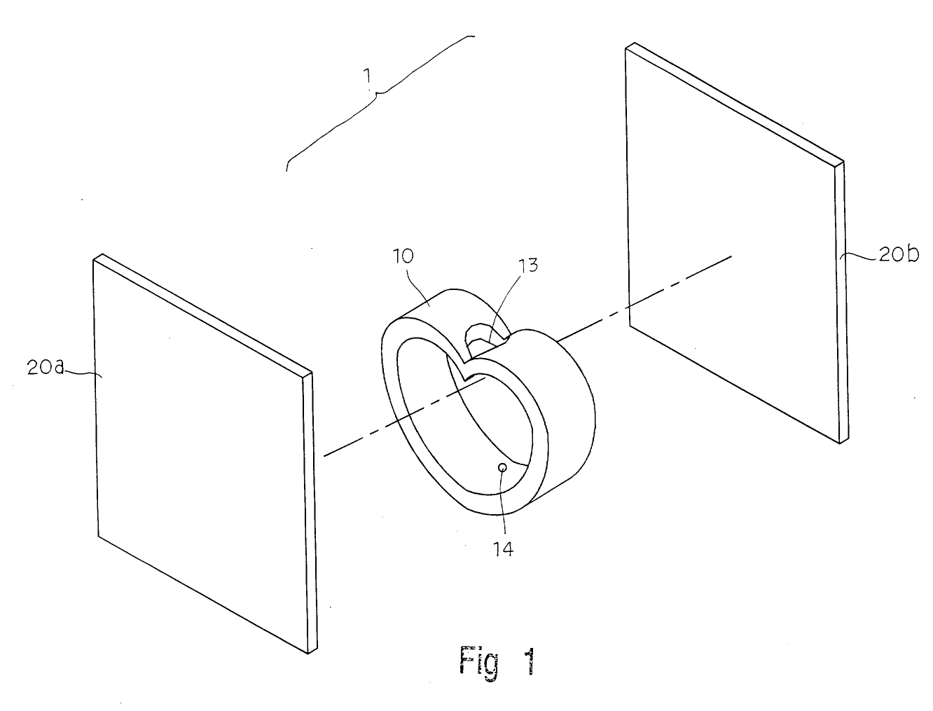

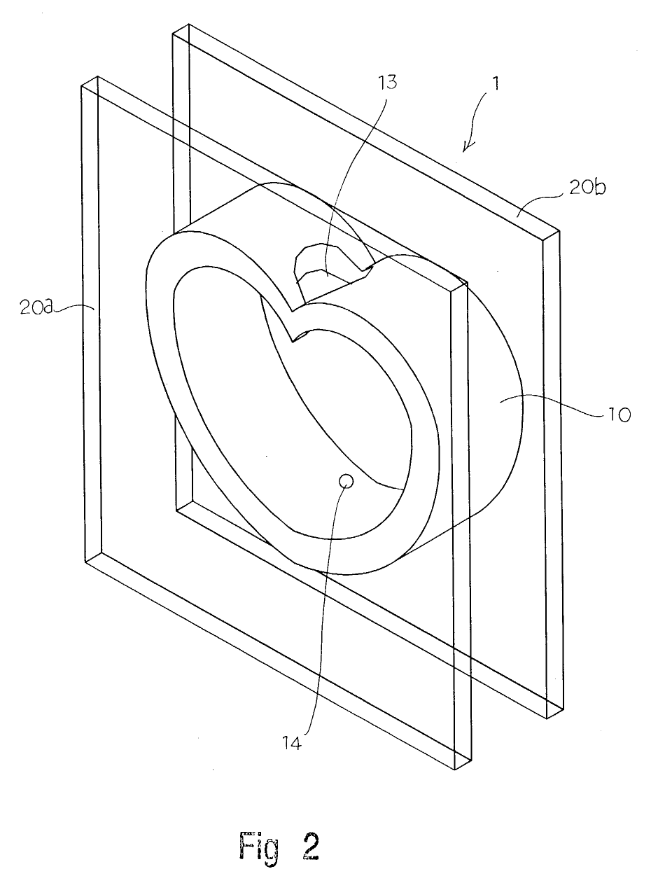

Please refer to FIGS. 1 and 2. The present invention provides a glass sound case different from traditional sound cases wherein the glass sound case 1 consists of a frame 10 and two transparent glass covers 20a, 20b.

The frame 10 is a one-piece hollow frame with variable formation (in this case the frame is shaped as a “heart”). Inside the frame there are several speakers 11 and relative components. On the surface there is a sound release hole 13 through which the amplified sound is sent out and a power cord hole 14 for power supply.

The glass covers 20a, 20b can come in different shapes for various formation. By covering the glass covers 20a, 20b on either side of the frame 10, the glass covers 20a, 20b are formed into different modeling and securing the sound case 1 in place.

This completes the basic structure of the glass sound case in the present invention.

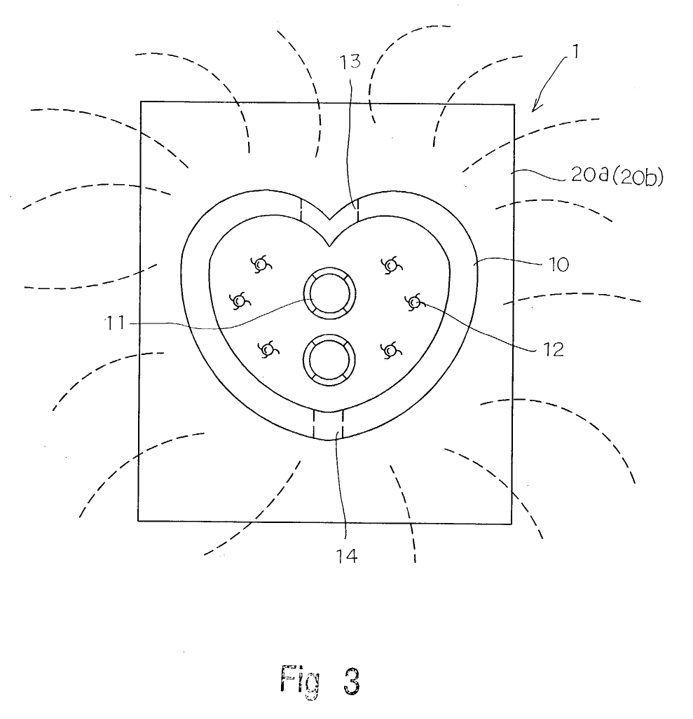

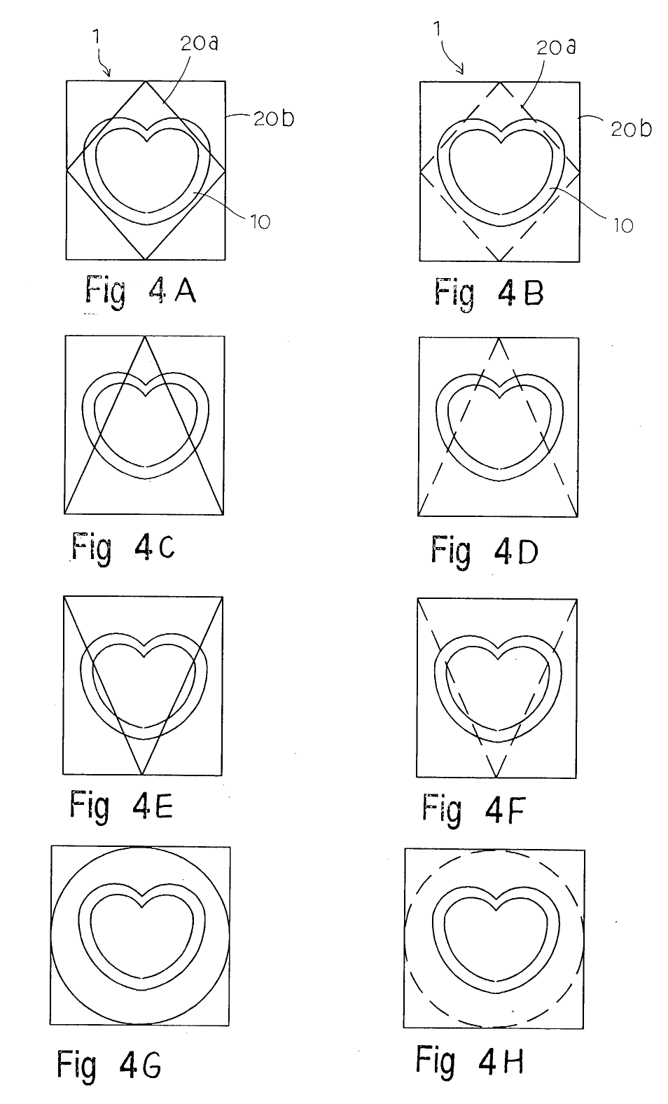

Please refer to FIG. 3. Besides the speakers 11 on the frame 10, several LEDs or luminous components 12 are installed on the surface. By supplying power to the components with circuit to make the components glitter intermittently, the LEDs or luminous components 12 flavor the sound case with more beautifying effects.

Please refer to 4A, 4B, 4C, 4D, 4E, 4F, 4G and 4H for the application of the present invention. First of all, the hollow frame 10 with variable formation is equipped with speakers 11 and relative components inside and several LED or luminous components 12 on the surface. Then, the frame covered by two transparent glass covers 20a, 20b on either side is turned into a closed box.

Finally, the assemblage completes by gluing all parts together. After all is done, the user is able to see the fast, slow, big and small vibration of the inner speakers 11 through the glass covers 20a, 20b and the frame 10. With the supplementation of the glittering of the LED or luminous components 12, the glass sound case is full of dynamic visual variation and thus completes the sound case with variable formation and that provides beautifying effects.

The structure of the frame 10 and glass covers 20a, 20b with variable formation provides the following advantages:

1. Providing Beautifying Effects and Visual Variation:

Since the glass covers of the glass sound case in the present invention are able to switch places during assemblage and the frame can be made of different shapes, this sound case has such functions as variable formation and beautifying effects. Meanwhile, the transparency of the glass covers exposes the inner part of the frame, which highlights the operation of speakers and LEDs or luminous components, adding more visual variation to the sound case.

2. Fit in with the Environmental Protection Requirement:

Because the frame and glass covers of the glass sound case in the present invention are made of recyclable materials (aluminum, glass), which can be discomposed and recycled when being discarded, the sound case eliminates the possibilities of polluting the environment and fits in with the environment protection requirement.

To summarize the above description, the glass sound case in the present invention composed of a frame and glass covers with variable formation and shapes can present the inner structure of the frame, providing beautifying effect and visual variation, which practically meets the qualifications for invention based on new type and improvement. Accordingly, an application is submitted for examination.

What is claimed is:

1. A glass sound case consisting of:
an one-piece hollow frame with variable formation and a sound release hole and a power cord hole on the surface;
two transparent glass covers with variable formation being covered on either side of said frame to secure said sound case;
a combination of said two components completes said sound case with variable formation that provides beautifying effects and visual variation effects.

2. The glass sound case of claim 1, wherein several LEDs or luminous components are placed inside said frame to give visual variation effects.

3. The glass sound case of claim 1, wherein said transparent glass covers on said frames can come in two different shapes.

4. The glass sound case of claim 1, wherein said glass covers can be more than one pieces.

5. The sound case of claim 1, wherein said frame and said glass covers can have several kinds of formation.

6. The sound case of claim 1, wherein said sound release hole and power cord hole can also be installed adequately on said glass covers.
